(19) United States
(12) Patent Application Publication
(10) Pub. No.: US 2012/0052353 A1
(43) Pub. Date: Mar. 1, 2012

(54) CYLINDRICAL NICKEL-HYDROGEN STORAGE BATTERY

(75) Inventors: Hiromasa Sugii, Itano-gun (JP); Makoto Ochi, Myozai-gun (JP); Akira Nishida, Itano-gun (JP); Kazuhiro Kitaoka, Naruto-shi (JP)

(73) Assignee: SANYO ELECTRIC CO., LTD., Osaka (JP)

(21) Appl. No.: 13/213,584

(22) Filed: Aug. 19, 2011

(30) Foreign Application Priority Data
Aug. 27, 2010 (JP) 2010-190728
Jul. 26, 2011 (JP) 2011-163384

(51) Int. Cl. H01M 10/36

(52) U.S. Cl. 429/94

(57) ABSTRACT

The invention is directed to provide a cylindrical nickel-hydrogen storage battery having high discharge power densities both at SOC 50% and at SOC 20%. In an alkaline storage battery according to an embodiment of the invention, a nickel positive electrode formed into a rectangular shape has a short side length of X and a long side length of Y, the ratio (Y/X) of the long side length to the short side length is 25 or more and 40 or less (25≦Y/X≦40), the short side length is 25 mm or more and 45 mm or less (25 mm≦X≦45 mm), and the battery capacity is 3 Ah or more and 7 Ah or less.

### TECHNICAL FIELD

The present invention relates to alkaline storage batteries suitable for application to vehicles such as hybrid electric vehicles (HEVs) and pure electric vehicles (PEVs), and in particular, relates to cylindrical nickel-hydrogen storage batteries that include a sealed battery container storing an alkaline electrolyte and a spiral electrode group having a nickel positive electrode filled with a positive electrode active material and formed into a rectangular shape, a negative electrode filled with a negative electrode active material and formed into a rectangular shape, and a separator formed into a rectangular shape.

### BACKGROUND ART

Recently, secondary batteries have been used for various applications such as cell phones, personal computers, power tools, hybrid electric vehicles (HEVs), and pure electric vehicles (PEVs), and alkaline storage batteries have been used for such applications. Among them, in particular, the alkaline storage batteries used for vehicles such as hybrid electric vehicles (HEVs) and pure electric vehicles (PEVs) have been required by the market to provide increased power.

As a response to this need for increased power, Japanese Patent No. 4235805 discloses a cylindrical nickel-hydrogen storage battery that includes a nickel positive electrode formed into a rectangular shape having a ratio (D/C) of the long side length (D) to the short side length (C) of 16 to 24 and having a short side length (C) of 30 to 45 mm, and that has a battery capacity of 4 to 7 Ah. In the cylindrical nickel-hydrogen storage battery disclosed in Japanese Patent No. 4235805, it was reported that the battery showed a high discharge power density around a state of charge (SOC) of 50%.

However, the study by the inventors has ascertained that the cylindrical nickel-hydrogen storage battery disclosed in Japanese Patent No. 4235805 and having the defined value ranges, which are a D/C of 16 to 24, a C of 30 to 45 mm, and a battery capacity of 4 to 7 Ah, has a largely decreased discharge power density at SOC 20% with respect to that at SOC 50%.

### SUMMARY

An advantage of some aspects of the invention is to provide a cylindrical nickel-hydrogen storage battery that is suitably used for hybrid electric vehicles (HEVs) and that has high discharge power densities both at SOC 50% and at SOC 20%.

In a cylindrical nickel-hydrogen storage battery according to an aspect of the invention, a nickel positive electrode formed into a rectangular shape has a short side length of X (mm) and a long side length of Y (mm), the ratio (Y/X) of the long side length to the short side length is 25 or more and 40 or less (25≦Y/X≦40), and the short side length is 25 mm or more and 45 mm or less (25 mm≦X≦45 mm). The cylindrical nickel-hydrogen storage battery has a battery capacity of 3 Ah or more and 7 Ah or less.

A battery test (discharge power density characteristics test) has revealed that the nickel-hydrogen storage battery that includes the nickel positive electrode having a ratio Y/X of the long side length Y to the short side length X of 25 to 40 and having a short side length of 25 to 45 mm and that satisfies a battery capacity of 3.0 to 7.0 Ah achieves a high discharge power density (Z1) of 1420 W/kg or more at SOC 50%, and a high discharge power density (Z2) of 1100 W/kg or more at SOC 20%, and has a high ratio (Z2/Z1) of the discharge power density (Z2) at SOC 20% to the discharge power density (Z1) at SOC 50% of 0.8 or more.

From the results, it is desirable that the nickel positive electrode have a ratio Y/X of the long side length Y to the short side length X of 25 to 40, and have a short side length of 25 to 45 mm, and that the battery capacity be 3.0 to 7.0 Ah.

In this case, the nickel positive electrode is preferably prepared by filling pores of a nickel sintered substrate with at least nickel hydroxide as a main positive electrode active material and zinc by impregnation treatment of an impregnation solution and alkaline treatment, namely, is preferably a sintered nickel positive electrode. This is because the sintered nickel positive electrode uses a sintered substrate and thus has excellent electric conductivity, while a non-sintered nickel positive electrode (for example, an electrode formed by filling a nickel foam with a positive electrode active material paste) has poor electric conductivity compared with that of the sintered electrode and shows significant effects caused by the reduced electric conductivity.

Capacity reduction due to memory effect must be suppressed in order to use a larger battery capacity in such a cylindrical nickel-hydrogen storage battery. Various studies have revealed that the capacity reduction due to the memory effect can be suppressed with a battery in which the nickel positive electrode contains zinc (Zn) in an amount of 8% by mass or less based on the nickel mass in the positive electrode active material, the alkaline electrolyte has an alkali concentration of 6.5 mol/L or less, and the alkaline electrolyte contains lithium (Li) in an amount of 0.3 mol/L or more. On this account, it is desirable that the nickel positive electrode contain zinc (Zn) in an amount of 8% by mass or less based on the nickel mass in the positive electrode active material, the alkaline electrolyte have an alkali concentration of 6.5 mol/L or less, and the alkaline electrolyte contain lithium (Li) in an amount of 0.3 mol/L or more.

It has also been revealed that the capacity reduction due to the memory effect can be suppressed with a battery in which the nickel positive electrode contains zinc in an amount of 8% by mass or less based on the nickel mass in the positive electrode active material, the alkaline electrolyte has an alkali concentration of 7.5 mol/L or less, and the alkaline electrolyte contains sodium (Na) in an amount of 0.4 mol/L or more and 5.3 mol/L or less and lithium (Li) in an amount of 0.3 mol/L or less. On this account, it is desirable that the nickel positive electrode contain zinc in an amount of 8% by mass or less based on the nickel mass in the positive electrode active material, the alkaline electrolyte have an alkali concentration of 7.5 mol/L or less, and the alkaline electrolyte contain sodium (Na) in an amount of 0.4 mol/L or more and 5.3 mol/L or less and lithium (Li) in an amount of 0.3 mol/L or less.

Furthermore, such a cylindrical nickel-hydrogen storage battery may use a rare earth-Mg—Ni hydrogen storage alloy (having a crystal structure such as a Ce₂Ni₇ type, a CeNi₃ type, and a Pr₅Co₁₅ type except for a CaCu₅ type) as the negative electrode active material. In this case, when the hydrogen storage alloy composition contains Mn and Co, long-term storage leads to the elution of Mn or Co into the electrolyte. The eluted Mn or Co reduced the thickness of the separator to cause a micro short circuit, and furthermore, long-term storage largely reduced the residual capacity. Therefore, it is desirable that the hydrogen storage alloy contain no Mn or Co.

A cylindrical nickel-hydrogen storage battery according to the present aspect of the invention employs a nickel positive electrode having a particular size and has battery capacity controlled within a particular range, and thus has high discharge power densities both at SOC 50% and at SOC 20%.

### BRIEF DESCRIPTION OF THE DRAWINGS

The invention will be described with reference to the accompanying drawings, wherein the sesame numbers refer to the same elements throughout.

FIG. 1 is a schematic sectional view showing a nickel-hydrogen storage battery as an embodiment of an alkaline storage battery of an embodiment of the invention.

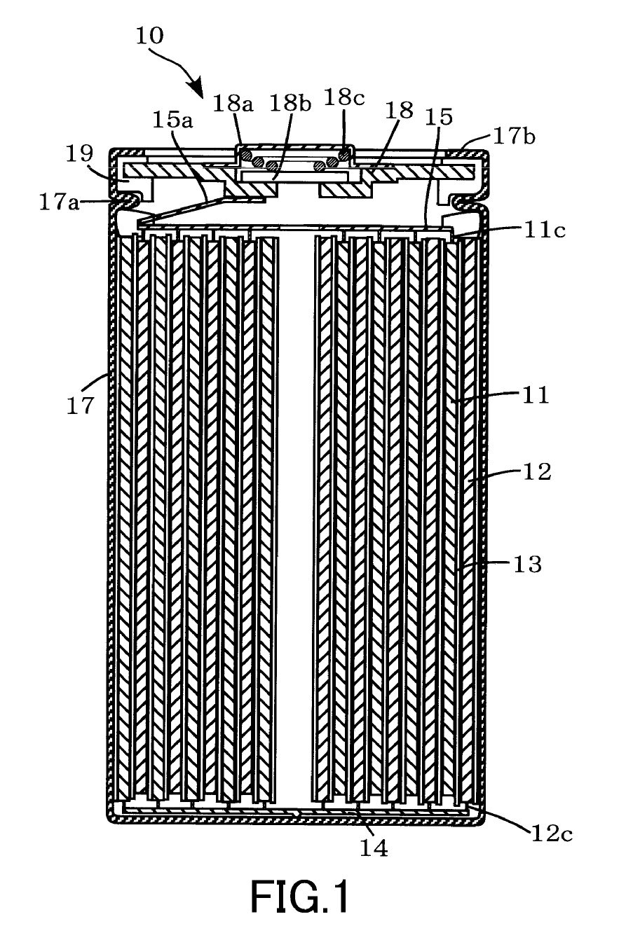

FIG. 2 is a graph showing relations between the ratio (Y/X) of the long side length to the short side length of the nickel positive electrode and the SOC 50% discharge power density Z1 (W/kg), the SOC 20% discharge power density Z2 (W/kg), and the ratio Z2/Z1.

### DESCRIPTION OF EXEMPLARY EMBODIMENTS

Embodiments of the invention will be described in detail below, but the invention is not limited to the embodiments, and various changes and modifications may be made in the invention as appropriate, without departing from the spirit and scope of the invention.

1. Nickel Positive Electrode

(1) Sintered Substrate

A nickel sintered substrate to be used is prepared as follows. For example, methyl cellulose (MC) as a thickener, polymeric hollow microspheres (for example, having a pore size of 60 μm), and water were mixed with nickel powder, and the whole was kneaded to prepare a nickel slurry. Next, the nickel slurry was applied onto both sides of a punching metal made from a nickel coated steel plate so as to have a predetermined thickness, and then the plate was heated in a reducing atmosphere at 1000° C. to remove the coated thickener and polymeric hollow microspheres and to sinter the nickel powder to each other to prepare a substrate. Here, the substrate prepared so as to have a thickness of 0.36 mm after the sintering was regarded as a nickel sintered substrate α, and that prepared so as to have a thickness of 0.30 mm after the sintering was regarded as a nickel sintered substrate β.

(2) Sintered Nickel Positive Electrode

A sintered nickel positive electrode 11 was prepared by filling pores of each of the nickel sintered substrates α and β prepared as above with nickel hydroxide and zinc hydroxide so as to have predetermined filling amounts (here, the filling amount of zinc was 7% by mass in terms of the mass ratio to nickel). In this case, the impregnation treatment of impregnating each of the obtained nickel sintered substrates α and β with an impregnation solution as described below, and the alkaline treatment with an alkaline treatment solution were repeated a predetermined amount of repetitions to fill pores of the nickel sintered substrate with nickel hydroxide and zinc hydroxide in predetermined amounts, and then the substrate was cut into a predetermined size to prepare each of the sintered nickel positive electrodes 11 (a1 to a11 and b1 to b3) filled with the positive electrode active material.

In this case, the used impregnation solution was an aqueous solution prepared by mixing nickel nitrate and zinc nitrate so as to have a predetermined molar ratio, and the used alkaline treatment solution was an aqueous sodium hydroxide (NaOH) solution having a specific gravity of 1.3. In order to, for example, improve high-temperature characteristics, the impregnation solution to be used may include cobalt nitrate, yttrium nitrate, ytterbium nitrate, or the like. Then, the nickel sintered substrate was immersed in the impregnation solution to impregnate pores of the nickel sintered substrate with the impregnation solution. Then, the substrate was dried, and next, immersed in the alkaline treatment solution for the alkaline treatment. This treatment converted the nickel salt and the zinc salt into nickel hydroxide and zinc hydroxide. Then, the substrate was sufficiently washed with water to remove the alkaline solution, and then dried. Such a series of positive electrode active material filling operations that includes impregnation with the impregnation solution, drying, immersion in the alkaline treatment solution, water washing, and drying was repeated several times to fill each of the nickel sintered substrates α and β with a predetermined amount of the positive electrode active material.

The nickel sintered substrate α (having a thickness of 0.36 mm) was cut into a size (Y/X=50) having a short side length (X) of 20.0 mm and a long side length (Y) of 990 mm to prepare a sintered nickel positive electrode a1. In a similar manner, the nickel sintered substrate α was cut into a size (Y/X=45) having a short side length (X) of 22.0 mm and a long side length (Y) of 990 mm to prepare a sintered nickel positive electrode a2; that was cut into a size (Y/X=40) having a short side length (X) of 25.0 mm and a long side length (Y) of 990 mm to prepare a sintered nickel positive electrode a3; that was cut into a size (Y/X=36) having a short side length (X) of 27.5 mm and a long side length (Y) of 990 mm to prepare a sintered nickel positive electrode a4; that was cut into a size (Y/X=33) having a short side length (X) of 30.0 mm and a long side length (Y) of 990 mm to prepare a sintered nickel positive electrode a5; that was cut into a size (Y/X=28) having a short side length (X) of 35.5 mm and a long side length (Y) of 990 mm to prepare a sintered nickel positive electrode a6; that was cut into a size (Y/X=25) having a short side length (X) of 40.0 mm and a long side length (Y) of 990 mm to prepare a sintered nickel positive electrode a7; that was cut into a size (Y/X=23) having a short side length (X) of 44.0 mm and a long side length (Y) of 990 mm to prepare a sintered nickel positive electrode a8; that was cut into a size (Y/X=20) having a short side length (X) of 50.0 mm and a long side length (Y) of 990 mm to prepare a sintered nickel positive electrode a9; that was cut into a size (Y/X=15) having a short side length (X) of 65.0 mm and a long side length (Y) of 990 mm to prepare a sintered nickel positive electrode a10; and that was cut into a size (Y/X=11) having a short side length (X) of 90.0 mm and a long side length (Y) of 990 mm to prepare a sintered nickel positive electrode all.

The nickel sintered substrate 13 (having a thickness of 0.30 mm) was cut into a size (Y/X=60) having a short side length (X) of 20.0 mm and a long side length (Y) of 1200 mm to prepare a sintered nickel positive electrode b1; that was cut into a size (Y/X=30) having a short side length (X) of 40.0 mm and a long side length (Y) of 1200 mm to prepare a sintered nickel positive electrode b2; and that was cut into a size (Y/X=27) having a short side length (X) of 45.0 mm and a long side length (Y) of 1200 mm to prepare a sintered nickel positive electrode b3.

2. Hydrogen Storage Alloy Negative Electrode

A hydrogen storage alloy negative electrode 12 was prepared by coating a negative electrode substrate made from a punching metal with a hydrogen storage alloy slurry. In this case, metallic elements such as rare earth elements (Ln; for example, La, Pr, and Nd), magnesium (Mg), nickel (Ni), and aluminum (Al) were mixed in a predetermined molar ratio. Next, the mixture was placed in a high-frequency induction heater in an argon gas atmosphere to be melted, and then quenched to prepare a hydrogen storage alloy ingot. Next, the obtained hydrogen storage alloy ingot was mechanically pulverized in an inert gas atmosphere to give a hydrogen storage alloy powder. It was ascertained that the prepared hydrogen storage alloy had a composition formula of La_{0.63}Nd_{0.27}Mg_{0.10}Ni_{3.55}Al_{0.20} and had an average particle diameter of 25 μm, which indicated 50% of mass integral.

Then, 100 parts by mass of the obtained hydrogen storage alloy powder was mixed with 0.5 part by mass of styrene butadiene rubber (SBR) as a water-insoluble polymer binder, 0.03 part by mass of carboxymethyl cellulose (CMC) as a thicker, and an appropriate amount of pure water and the whole was kneaded to prepare a hydrogen storage alloy slurry. Next, the obtained hydrogen storage alloy slurry was applied to both sides of a negative electrode substrate made from a punching metal (made from a nickel coated steel plate). Then, the substrate was dried and rolled so as to have a predetermined packing density, and cut into a predetermined size to prepare each of the hydrogen storage alloy negative electrodes 12 (c1 to c11 and d1 to d3).

Here, the substrate having a thickness of 0.19 mm was cut into a size having a short side length of 20.0 mm and a long side length of 1065 mm to prepare a hydrogen storage alloy negative electrode c1; that was cut into a size having a short side length of 22.0 mm and a long side length of 1065 mm to prepare a hydrogen storage alloy negative electrode c2; that was cut into a size having a short side length of 25.0 mm and a long side length of 1065 mm to prepare a hydrogen storage alloy negative electrode c3; that was cut into a size having a short side length of 27.5 mm and a long side length of 1065 mm to prepare a hydrogen storage alloy negative electrode c4; that was cut into a size having a short side length of 30.0 mm and a long side length of 1065 mm to prepare a hydrogen storage alloy negative electrode c5; that was cut into a size having a short side length of 35.5 mm and a long side length of 1065 mm to prepare a hydrogen storage alloy negative electrode c6; that was cut into a size having a short side length of 40.0 mm and a long side length of 1065 mm to prepare a hydrogen storage alloy negative electrode c7; that was cut into a size having a short side length of 44.0 mm and a long side length of 1065 mm to prepare a hydrogen storage alloy negative electrode c8; that was cut into a size having a short side length of 50.0 mm and a long side length of 1065 mm to prepare a hydrogen storage alloy negative electrode c9; that was cut into a size having a short side length of 65.0 mm and a long side length of 1065 mm to prepare a hydrogen storage alloy negative electrode c10; and that was cut into a size having a short side length of 90.0 mm and a long side length of 1065 mm to prepare a hydrogen storage alloy negative electrode cll.

The substrate having a thickness of 0.16 mm was cut into a size having a short side length of 20.0 mm and a long side length of 1290 mm to prepare a hydrogen storage alloy negative electrode d1; that was cut into a size having a short side length of 40.0 mm and a long side length of 1290 mm to prepare a hydrogen storage alloy negative electrode d2; and that was cut into a size having a short side length of 45.0 mm and a long side length of 1290 mm to prepare a hydrogen storage alloy negative electrode d3.

3. Nickel-Hydrogen Storage Battery

Next, each of the nickel positive electrodes 11 (a1 to a11 and b1 to b3) and each of the hydrogen storage alloy negative electrodes 12 (c1 to c11 and d1 to d3) prepared as described above were used, and a separator 13 made from a polyolefin nonwoven fabric was interposed between them. The whole was spirally wound to prepare a spiral electrode group. From the upper part of the spiral electrode group prepared in this manner, a substrate exposed portion 11c of the nickel positive electrode 11 was exposed, and from the lower part, a substrate exposed portion 12c of the hydrogen storage alloy electrode 12 was exposed. Next, to the substrate exposed portion 12c exposed from the lower end face of the obtained spiral electrode group, a negative electrode collector 14 was welded, and onto the substrate exposed portion 11c of the nickel electrode 11 exposed from the upper end face of the spiral electrode group, a positive electrode collector 15 was welded to prepare an electrode assembly.

Next, the obtained electrode assembly was stored in a cylinder-shaped outer can 17 that was made from nickel coated iron and that had a bottom (the outer surface of the bottom served as a negative electrode external terminal), and the negative electrode collector 14 was welded to the inner bottom face of the outer can 17. Additionally, a collector lead part 15a led from the positive electrode collector 15 was welded to the bottom part of a sealing plate 18 that served as a positive electrode terminal and that had a peripheral part with an insulating gasket 19 installed. The sealing plate 18 had a positive electrode cap 18a, and the positive electrode cap 18a included a pressure valve (not shown in the drawing) composed of a valve 18b that would be deformed at a predetermined pressure and a spring 18c.

Next, on the upper peripheral part of the outer can 17, an annular groove 17a was formed, into which an alkaline electrolyte was poured, and the insulating gasket 19 installed on the peripheral part of the sealing plate 18 was placed on the annular groove 17a formed on the upper part of the outer can 17. Then, an open end 17b of the outer can 17 was crimped to prepare a plurality of nickel-hydrogen storage batteries 10 (A, B, C, D, E, F, G, H, I, J, K, L, M, and N). Here, the alkaline electrolyte had an alkali concentration of 6.2 mol/L, and the alkaline electrolyte included Li in an amount of 0.40 mol/L, K in an amount of 5.43 mol/L, and Na in an amount of 0.37 mol/L.

Here, the nickel positive electrode a1 and the hydrogen storage alloy negative electrode c1 were used to prepare a battery A. In a similar manner, the nickel positive electrode a2 and the hydrogen storage alloy negative electrode c2 were used to prepare a battery B; the nickel positive electrode a3 and the hydrogen storage alloy negative electrode c3 were used to prepare a battery C; the nickel positive electrode a4 and the hydrogen storage alloy negative electrode c4 were used to prepare a battery D; and the nickel positive electrode a5 and the hydrogen storage alloy negative electrode c5 were used to prepare a battery E. The nickel positive electrode a6 and the hydrogen storage alloy negative electrode c6 were used to prepare a battery F; the nickel positive electrode a7 and the hydrogen storage alloy negative electrode c7 were used to prepare a battery G; the nickel positive electrode a8 and the hydrogen storage alloy negative electrode c8 were used to prepare a battery H; the nickel positive electrode a9 and the hydrogen storage alloy negative electrode c9 were used to prepare a battery I; the nickel positive electrode al0 and the hydrogen storage alloy negative electrode c10 were used to prepare a battery J; and the nickel positive electrode all and the hydrogen storage alloy negative electrode cll were used to prepare a battery K. The nickel positive electrode b1 and the hydrogen storage alloy negative electrode d1 were used to prepare a battery L; the nickel positive electrode b2 and the hydrogen storage alloy negative electrode d2 were used to prepare a battery M; and the nickel positive electrode b3 and the hydrogen storage alloy negative electrode d3 were used to prepare a battery N.

Next, each of the batteries (A, B, C, D, E, F, G, H, I, J, K, L, M, and N) was charged in a temperature environment of 25° C. at a charging current of 0.5 It that was calculated from the active material amount of the nickel positive electrode to SOC 120%, then left in a temperature environment of 25° C. for 1 hour, and left in a temperature environment of 60° C. for 24 hours. Next, the battery was discharged in a temperature environment of 40° C. at a discharging current of 1 It until the battery voltage reached 0.9 V. Such a cycle was repeated twice to activate each battery.

Next, the battery was charged in a temperature environment of 25° C. at a charging current of 0.5 It until the voltage was reduced by ΔV=10 mV from the peak voltage. Then, the battery was left in a temperature environment of 25° C. for one hour, and discharged at a discharging current of 1.0 It until the battery voltage reached 1.0 V. The discharging capacity at this time was determined as the battery capacity of each battery, and the results are shown in Table 1.

TABLE 1

| | Nickel positive electrode size | | | |
|---|---|---|---|---|
| | Short | Long | | Battery |
| Battery | side length | side length | | capacity |
| type | (X) | (Y) | Y/X | (Ah) |
| A | 20.0 mm | 990 mm | 50 | 2.4 |
| B | 22.0 mm | 990 mm | 45 | 2.6 |
| C | 25.0 mm | 990 mm | 40 | 3.0 |
| D | 27.5 mm | 990 mm | 36 | 3.3 |
| E | 30.0 mm | 990 mm | 33 | 3.6 |
| F | 35.5 mm | 990 mm | 28 | 4.4 |
| G | 40.0 mm | 990 mm | 25 | 4.8 |
| H | 44.0 mm | 990 mm | 23 | 5.3 |
| I | 50.0 mm | 990 mm | 20 | 6.0 |
| J | 65.0 mm | 990 mm | 15 | 7.8 |
| K | 90.0 mm | 990 mm | 11 | 10.8 |
| L | 20.0 mm | 1200 mm | 60 | 2.9 |
| M | 40.0 mm | 1200 mm | 30 | 6.2 |
| N | 45.0 mm | 1200 mm | 27 | 7.0 |

4. Battery Test

Each of the batteries A, B, C, D, E, F, G, H, I, J, K, L, M, and N was charged in a temperature environment of 25° C. at a charging rate of 1 It with respect to the battery capacity (nominal capacity) to 50% of the battery capacity (SOC 50%). Then, the batteries were subjected to discharging at 40 A, a break, charging at 20 A, a break, discharging at 80 A, a break, charging at 40 A, a break, discharging at 120 A, a break, charging at 60 A, a break, discharging at 160 A, a break, charging at 80 A, a break, discharging at 200 A, a break, and charging at 100 A in the given order. Each discharging was performed for 10 seconds, charging for 20 seconds, and break for 30 minutes. The battery voltages (V) when discharging for 10 seconds were plotted with respect to the discharge currents (A), and the straight line was determined by the method of least squares. Then, the product of the current value (A) at 0.9 V on the straight line and 0.9 V was calculated as a discharge power (W), and the quotient of the discharge power by the battery mass was calculated as a discharge power density Z1 (W/kg). The obtained results are shown in Table 2.

Next, each battery was charged in a temperature environment of 25° C. at a charging rate of 1 It with respect to the battery capacity (nominal capacity) to 20% of the battery capacity (SOC 20%). Then, in a similar manner to the above, the batteries were subjected to discharging at 40 A, a break, charging at 20 A, a break, discharging at 80 A, a break, charging at 40 A, a break, discharging at 120 A, a break, charging at 60 A, a break, discharging at 160 A, a break, charging at 80 A, a break, discharging at 200 A, a break, and charging at 100 A in the given order. Each discharging was performed for 10 seconds, charging for 20 seconds, and break for 30 minutes. The battery voltages (V) at the discharging for 10 seconds were plotted with respect to the discharging currents (A), and the straight line was determined by the method of least squares. Then, the product of the current value (A) at 0.9 V on the straight line and 0.9 V was calculated as a discharge power (W), and the quotient of the discharge power by the battery mass was calculated as a discharge power density Z2 (W/kg). The obtained results are shown in Table 2.

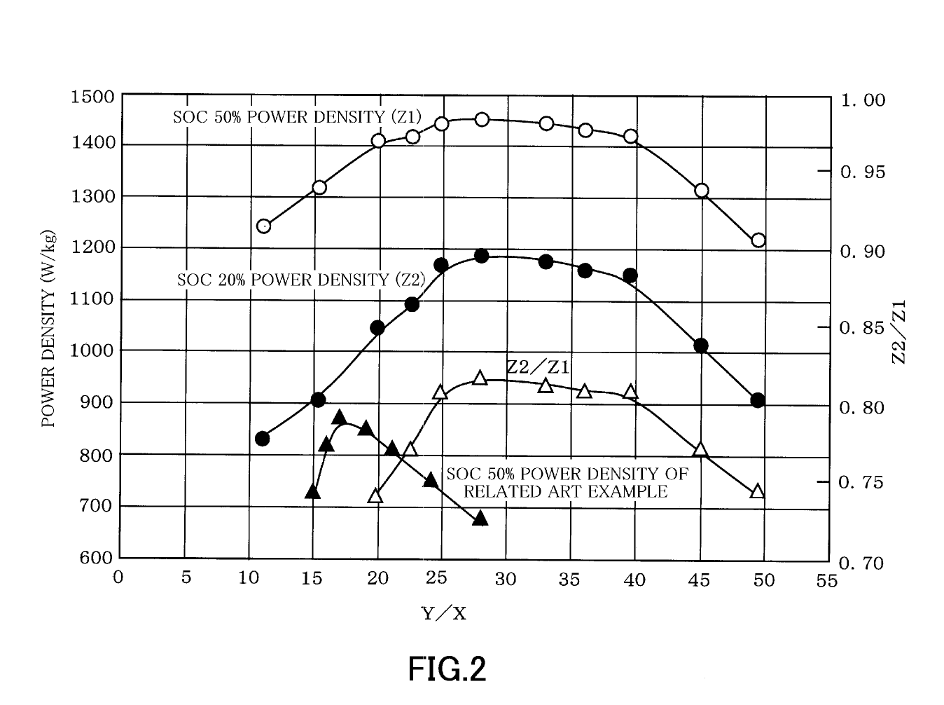

Then, based on the obtained results in Table 2, the SOC 50% discharge power density Z1 (W/kg), the SOC 20% discharge power density Z2 (W/kg), and the ratio Z2/Z1 are plotted with respect to Y/X to give the result shown in FIG. 2. FIG. 2 also shows the SOC 50% discharge power density of a related art example (described in Japanese Patent No. 4235805) (see filled triangles in FIG. 2) for reference. The SOC 50% discharge power density of the related art example was based on the description in Table 1 in Japanese Patent No. 4235805.

TABLE 2

| | Nickel positive | | | | | | |
|---|---|---|---|---|---|---|---|
| | electrode size | | | | SOC | SOC | |
| | Short | Long | | | 50% | 20% | |
| | side | side | | | power | power | Power |
| | length | length | | Battery | density | density | density |
| Battery | (X) | (Y) | | capacity | Z1 | Z2 | ratio |
| type | (mm) | (mm) | Y/X | (Ah) | (W/kg) | (W/kg) | (Z2/Z1) |
| A | 20.0 | 990 | 50 | 2.4 | 1216 | 905 | 0.74 |
| B | 22.0 | 990 | 45 | 2.6 | 1313 | 1013 | 0.77 |
| C | 25.0 | 990 | 40 | 3.0 | 1420 | 1148 | 0.81 |
| D | 27.5 | 990 | 36 | 3.3 | 1432 | 1158 | 0.81 |
| E | 30.0 | 990 | 33 | 3.6 | 1445 | 1173 | 0.81 |
| F | 35.5 | 990 | 28 | 4.4 | 1452 | 1185 | 0.82 |
| G | 40.0 | 990 | 25 | 4.8 | 1443 | 1165 | 0.81 |
| H | 44.0 | 990 | 23 | 5.3 | 1417 | 1092 | 0.77 |
| I | 50.0 | 990 | 20 | 6.0 | 1410 | 1045 | 0.74 |
| J | 65.0 | 990 | 15 | 7.8 | 1317 | 906 | 0.69 |
| K | 90.0 | 990 | 11 | 10.8 | 1240 | 830 | 0.67 |
| L | 20.0 | 1200 | 60 | 2.9 | 1299 | 1012 | 0.78 |
| M | 40.0 | 1200 | 30 | 6.2 | 1444 | 1178 | 0.82 |
| N | 45.0 | 1200 | 27 | 7.0 | 1425 | 1155 | 0.81 |

The results in Table 2 and FIG. 2 have revealed that each of the batteries C, D, E, F, and G and the batteries M and N that include the nickel positive electrode having a ratio Y/X of the long side length Y to the short side length X of 25 to 40 and having a short side length X of 25 to 45 mm and that satisfy a battery capacity of 3.0 to 7.0 Ah has a high discharge power density Z1 of 1420 W/kg or more at SOC 50%, a high discharge power density Z2 of 1100 W/kg or more at SOC 20%, and a high ratio (Z2/Z1) of Z2 to Z1 of 0.8 or more.

In contrast, it is revealed that each of the batteries A, B, H, I, J, K, and L that include the nickel positive electrode having a ratio Y/X of the long side length Y to the short side length X of more than 40 or less than 25, and having a short side length X of less than 25 mm or more than 40 mm, and that satisfy a battery capacity of less than 3.0 Ah or more than 7.0 Ah has a discharge power density Z1 of less than 1420 W/kg at SOC 50%, a discharge power density Z2 of less than 1100 W/kg at SOC 20%, and a ratio (Z2/Z1) of Z2 to Z1 of 0.78 or less.

The following shows the reason why each of the batteries H, I, J, and K that include the nickel positive electrode having a ratio Y/X of the long side length Y to the short side length X of less than 25 has the reduced discharge power density Z1 at SOC 50%, the reduced discharge power density Z2 at SOC 20%, and the largely reduced ratio (Z2/Z1) of Z2 to Z1. The nickel positive electrode having a longer short side length X increases the distance moved of electrons in the short side direction. In this case, at SOC 50% or 20%, especially at SOC 20%, nickel hydroxide or cobalt hydroxide has a reduced ionic charge of the metal ion to reduce the electric conductivity of the nickel positive electrode. As a result, it is supposed that the longer short side length X readily affects the battery to reduce the discharge power density Z1 at SOC 50% and the discharge power density Z2 at SOC 20% and to largely reduce the ratio (Z2/Z1) of Z2 to Z1.

The following shows the reason why each of the batteries A, B, and L that include the nickel positive electrode having a ratio Y/X of the long side length Y to the short side length X of more than 40 has the reduced discharge power density Z1 at SOC 50%, the reduced discharge power density Z2 at SOC 20%, and the largely reduced ratio (Z2/Z1) of Z2 to Z1. Each of the batteries A, B, and L has a small battery capacity of less than 3.0 Ah, and thus the discharging of the same capacity leads to discharging to a lower SOC region. Hence, it is supposed that even when the nickel positive electrode has a small short side length X, at SOC 50% or 20%, especially at SOC 20%, the reduction in the electric conductivity of the positive electrode readily affects the battery to reduce the discharge power density Z1 at SOC 50% and the discharge power density Z2 at SOC 20% and to largely reduce the ratio (Z2/Z1) of Z2 to Z1.

In this case, although a larger long side length Y may achieve a comparatively high power density similar to the battery L, the electrode sheet must be thinner in order to achieve this longer length. On this account, the upper limit in the invention of the long side length Y is 1200 mm in consideration of workability, operability, and the like.

Comprehensively considering the above results, a nickel-hydrogen storage battery having a higher discharge power density than that of a related art battery can be provided by including the nickel positive electrode having a ratio Y/X of the long side length Y to the short side length X of 25 to 40 and having a short side length X of 25 to 45 mm, and by satisfying a battery capacity of 3.0 to 7.0 Ah. The electric conductivity reduction effect in the nickel positive electrode is remarkable in a non-sintered positive electrode that includes a nickel foam positive electrode substrate filled with a positive electrode active material. Thus, the invention is preferably applied to a sintered nickel positive electrode in order to obtain such advantages.

5. Studies on Amount of Zinc in Nickel Positive Electrode and Alkali Concentration and Li Content in Alkaline Electrolyte

Next, the amount of zinc in the nickel positive electrode and the alkali concentration and Li content in the alkaline electrolyte were studied. A nickel positive electrode having the same size as that of the nickel positive electrode a3 was prepared by filling pores of the nickel sintered substrate a described above with nickel hydroxide and zinc hydroxide in predetermined filling amounts (here, the filling amount of zinc was increased from 7% by mass to 8% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration increased from 6.2 mol/L to 6.5 mol/L and including Li in an amount reduced from 0.40 mol/L to 0.30 mol/L were used to prepare a nickel-hydrogen storage battery in a manner similar to the above, and the battery was regarded as a battery O. In this case, the alkaline electrolyte included K in an amount of 5.81 mol/L and Na in an amount of 0.39 mol/L.

In a similar manner, a nickel positive electrode having the same size as that of the nickel positive electrode a3 was prepared by filling pores of the nickel sintered substrate α described above with nickel hydroxide and zinc hydroxide in predetermined filling amounts (here, the filling amount of zinc was increased from 7% by mass to 8% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration increased from 6.2 mol/L to 6.7 mol/L and including Li in an amount reduced from 0.40 mol/L to 0.25 mol/L were used to prepare a nickel-hydrogen storage battery in a similar manner to the above, and the battery was regarded as a battery P. In this case, the alkaline electrolyte included K in an amount of 6.05 mol/L and Na in an amount of 0.40 mol/L.

A nickel positive electrode having the same size as that of the nickel positive electrode a3 was prepared by filling pores of the nickel sintered substrate α described above with nickel hydroxide and zinc hydroxide in predetermined filling amounts (here, the filling amount of zinc was increased from 7% by mass to 11% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration increased from 6.2 mol/L to 6.5 mol/L and including Li in an amount reduced from 0.40 mol/L to 0.30 mol/L were used to prepare a nickel-hydrogen storage battery in a similar manner to the above, and the battery was regarded as a battery Q. In this case, the alkaline electrolyte included K in an amount of 5.81 mol/L and Na in an amount of 0.39 mol/L.

A nickel positive electrode having the same size as that of the nickel positive electrode a3 was prepared by filling pores of the nickel sintered substrate α described above with nickel hydroxide and zinc hydroxide in predetermined filling amounts (here, the filling amount of zinc was increased from 7% by mass to 16% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration increased from 6.2 mol/L to 6.5 mol/L and including Li in an amount reduced from 0.40 mol/L to 0.30 mol/L were used to prepare a nickel-hydrogen storage battery in a similar manner to the above, and the battery was regarded as a battery R. In this case, the alkaline electrolyte included K in an amount of 5.81 mol/L and Na in an amount of 0.39 mol/L.

A nickel positive electrode having the same size as that of the nickel positive electrode a3 was prepared by filling pores of the nickel sintered substrate α described above with nickel hydroxide and zinc hydroxide in predetermined filling amounts (here, the filling amount of zinc was increased from 7% by mass to 16% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration increased from 6.2 mol/L to 6.7 mol/L and including Li in an amount reduced from 0.40 mol/L to 0.25 mol/L were used to prepare a nickel-hydrogen storage battery in a similar manner to the above, and the battery was regarded as a battery S. In this case, the alkaline electrolyte included K in an amount of 6.05 mol/L and Na in an amount of 0.40 mol/L.

Then, each of the battery C described above and the obtained batteries O, P, Q, R, and S was charged at a charging current of 15 It until the voltage reached SOC 80%, and then discharged at a discharging current of 15 It until the voltage reached SOC 20%. Such a cycle was repeated as a partial charge and discharge cycling test until the quantity of discharge electricity reached 40 kAh. The ratio of the discharging capacity after the quantity of discharge electricity reached 40 kAh to the discharging capacity at the initial state was calculated as a partial discharging capacity ratio. The results are shown in Table 3.

TABLE 3

| | Nickel positive | | | | | | | |
|---|---|---|---|---|---|---|---|---|
| | electrode size | | | | | | | |
| | Short | | | Zn amount in | | Alkaline electrolyte | | Partial |
| | side | Long side | | positive | Battery | Alkali | Li | discharging |
| Battery | length X | length Y | | electrode (% | capacity | concentration | concentration | capacity ratio |
| type | (mm) | (mm) | Y/X | by mass) | (Ah) | (mol/L) | (mol/L) | (%) |
| C | 25.0 | 990 | 40 | 7 | 3.0 | 6.2 | 0.40 | 19 |
| O | 25.0 | 990 | 40 | 8 | 3.0 | 6.5 | 0.30 | 17 |
| P | 25.0 | 990 | 40 | 8 | 3.0 | 6.7 | 0.25 | 12 |
| Q | 25.0 | 990 | 40 | 11 | 3.0 | 6.5 | 0.30 | 12 |
| R | 25.0 | 990 | 40 | 16 | 3.0 | 6.5 | 0.30 | 11 |
| S | 25.0 | 990 | 40 | 16 | 3.0 | 6.7 | 0.25 | 9 |

The results in Table 3 reveal that each of the batteries P, Q, R, and S has a largely reduced discharging capacity ratio (partial discharging capacity ratio) after the discharge of 40 kAh. Contrarily, it is revealed that each of the batteries C and O has a largely improved discharging capacity ratio (partial discharging capacity ratio) after the discharge of 40 kAh. In other words, a battery that includes a positive electrode including zinc (Zn) in the same amount as those in the batteries C and O, and that includes an alkaline electrolyte having the same concentration as those in the batteries C and O, and including lithium (Li) in the same amount as those in the batteries C and O can largely suppress the capacity reduction (memory effect) after the discharge of 40 kAh.

That is to say that the capacity reduction due to the memory effect must be suppressed in order to use a larger battery capacity in such a nickel-hydrogen storage battery. The results in Table 3 show that the capacity reduction due to the memory effect can be suppressed with a battery in which the nickel positive electrode contains zinc (Zn) in an amount of 8% by mass or less based on the nickel mass in the positive electrode active material, the alkaline electrolyte has an alkali concentration of 6.5 mol/L or less, and the alkaline electrolyte contains lithium (Li) in an amount of 0.3 mol/L or more. Consequently, it is desirable that the nickel positive electrode contain zinc (Zn) in an amount of 8% by mass or less based on the nickel mass in the positive electrode active material, the alkaline electrolyte have an alkali concentration of 6.5 mol/L or less, and the alkaline electrolyte contain lithium (Li) in an amount of 0.3 mol/L or more.

6. Study on Alkali Concentration and Na Content in Alkaline Electrolyte with Nickel Positive Electrode Containing Zinc in Amount of 8% by Mass or Less and Alkaline Electrolyte Containing Li in Amount of 0.3 mol/L or Less

Next, the amount of zinc in the nickel positive electrode and the alkali concentration and Na content in the alkaline electrolyte were studied. A nickel positive electrode having the same size as that of the nickel positive electrode a3 was prepared by filling pores of the nickel sintered substrate a described above with nickel hydroxide and zinc hydroxide in predetermined filling amounts (here, the filling amount of zinc was increased from 7% by mass to 8% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration of 6.2 mol/L and including K in an amount of 5.55 mol/L, Na in an amount of 0.40 mol/L, and Li in an amount of 0.25 mol/L were used to prepare a nickel-hydrogen storage battery in a similar manner to the above, and the battery was regarded as a battery O1.

In a similar manner, a nickel positive electrode having the same size as that of the nickel positive electrode a3 was prepared by filling pores of the nickel sintered substrate α described above with nickel hydroxide and zinc hydroxide in predetermined filling amounts (here, the filling amount of zinc was increased from 7% by mass to 8% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration of 6.5 mol/L and including K in an amount of 5.30 mol/L, Na in an amount of 0.98 mol/L, and Li in an amount of 0.23 mol/L were used to prepare a nickel-hydrogen storage battery in a similar manner to the above, and the battery was regarded as a battery O2.

A nickel positive electrode having the same size as that of the nickel positive electrode a3 was prepared by filling pores of the nickel sintered substrate α described above with nickel hydroxide and zinc hydroxide in predetermined filling amounts (here, the filling amount of zinc was increased from 7% by mass to 11% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration of 6.7 mol/L and including K in an amount of 3.82 mol/L, Na in an amount of 2.68 mol/L, and Li in an amount of 0.20 mol/L were used to prepare a nickel-hydrogen storage battery in a similar manner to the above, and the battery was regarded as a battery O3.

A nickel positive electrode having the same size as that of the nickel positive electrode a3 was prepared by filling pores of the nickel sintered substrate α described above with nickel hydroxide and zinc hydroxide in predetermined filling amounts (here, the filling amount of zinc was increased from 7% by mass to 16% by mass in terms of the mass ratio to nickel). The nickel positive electrode and the hydrogen storage alloy negative electrode c3 were used to prepare a spiral electrode group. Then, the obtained spiral electrode group and an alkaline electrolyte having an alkali concentration of 7.5 mol/L and including K in an amount of 1.98 mol/L, Na in an amount of 5.30 mol/L, and Li in an amount of 0.22 mol/L were used to prepare a nickel-hydrogen storage battery in a similar manner to the above, and the battery was regarded as a battery O4.

Then, each of the battery C and the battery O described above and the obtained batteries O1, O2, O3, and O4 was charged at a charging current of 15 It until the voltage reached SOC 80%, and then discharged at a discharging current of 15 It until the voltage reached SOC 20%. Such a cycle was repeated as a partial charge and discharge cycling test until the quantity of discharge electricity reached 40 kAh. The ratio of the discharging capacity after the quantity of discharge electricity reached 40 kAh to the discharging capacity at the initial state was calculated as a partial discharging capacity ratio. The results are shown in Table 4.

TABLE 4

| | Zn | | | | | |
|---|---|---|---|---|---|---|
| | amount in | Breakdown of alkaline electrolytes | | | | |
| | positive | Alkali | K | Na | Li | Partial |
| | electrode | concen- | concen- | concen- | concen- | discharging |
| Battery | (% by | tration | tration | tration | tration | capacity |
| type | mass) | (mol/L) | (mol/L) | (mol/L) | (mol/L) | ratio (%) |
| C | 7 | 6.2 | 5.43 | 0.37 | 0.40 | 19 |
| O | 8 | 6.5 | 5.81 | 0.39 | 0.30 | 17 |
| O1 | 8 | 6.2 | 5.55 | 0.40 | 0.25 | 17 |
| O2 | 8 | 6.5 | 5.30 | 0.98 | 0.23 | 18 |
| O3 | 8 | 6.7 | 3.82 | 2.68 | 0.20 | 18 |
| O4 | 8 | 7.5 | 1.98 | 5.30 | 0.22 | 17 |

The results in Table 4 reveal that each discharging capacity ratio (partial discharging capacity ratio) after the discharge of 40 kAh of the batteries O1, O2, O3, and O4 is not largely changed compared with that of the battery O. This shows that the capacity reduction due to the memory effect can be suppressed with a battery in which the nickel positive electrode contains zinc (Zn) in an amount of 8% by mass or less based on the nickel mass in the positive electrode active material and the alkaline electrolyte contains Na in an amount of 0.4 mol/L or more and 5.3 mol/L or less and has an alkali concentration of 7.5 mol/L or less even when the alkaline electrolyte contain lithium (Li) in an amount of 0.3 mol/L or less.

Namely, a battery using the alkaline electrolyte including Na in the same amount (0.4 mol/L or more and 5.3 mol/L or less) and having the same alkali concentration (7.5 mol/L or less) as those in the batteries O1, O2, O3, and O4 can suppress the reduction in charging efficiency associated with the repetition of charging and discharging even when the alkaline electrolyte contains lithium (Li) in an amount of 0.3 mol/L or less. Hence, such a battery can obtain the partial discharging capacity after the repetition of charging and discharging equivalent to that of the battery in which the nickel positive electrode contains zinc (Zn) in an amount of 8% by mass or less based on the nickel mass in the positive electrode active material, the alkaline electrolyte has an alkali concentration of 6.5 mol/L or less, and the alkaline electrolyte contains lithium (Li) in an amount of 0.3 mol/L or more.

7. Stud_{y} on Hydrogen Storage Alloy Composition

Next, the composition of the hydrogen storage alloy as the negative electrode active material was studied. A hydrogen storage alloy negative electrode having the same size as that of the hydrogen storage alloy negative electrode c3 (the general formula of the hydrogen storage alloy as the negative electrode active material is La_{0.63}Nd_{0.27}Mg_{0.10}Ni_{3.55}Al_{0.20}) was prepared by using a hydrogen storage alloy having an alloy composition of general formula: La_{0.63}Nd_{0.27}Mg_{0.10}Ni_{3.55}Al_{0.05}Mn_{0.05}Co_{0.10}. Next, the nickel positive electrode a3 described above and the obtained hydrogen storage alloy negative electrode were used to prepare a spiral electrode group. Then, the spiral electrode group and an alkaline electrolyte having an alkali concentration of 6.2 mol/L and a Li concentration of 0.40 mol/L were used to prepare a nickel-hydrogen storage battery in a similar manner as the above, and the battery was regarded as a battery T.

Each of the battery C described above and the obtained battery T was charged until the voltage reached SOC 80%, and left at an environmental temperature of 60° C. for three months. Then, the battery was discharged at an environmental temperature of 25° C. at a discharging current of 1 It until the battery voltage reached 1.0 V (cut voltage) to determine the discharge time, and from the discharge time, a residual discharging capacity was determined. The ratio to the discharging capacity at the initial state was determined as a residual discharging capacity ratio (%). The obtained results are shown in Table 5.

TABLE 5

| | Nickel positive | | | | | |
|---|---|---|---|---|---|---|
| | electrode size | | | | | Residual |
| | Short side | Long side | | Battery | | discharging |
| | length X | length Y | | capacity | Hydrogen storage alloy composition | capacity ratio |
| Battery type | (mm) | (mm) | Y/X | (Ah) | (general formula) | (%) |
| C | 25.0 | 990 | 40 | 3.0 | La_{0.63}Nd_{0.27}Mg_{0.10}Ni_{3.55}Al_{0.20} | 24 |
| T | 25.0 | 990 | 40 | 3.0 | La_{0.63}Nd_{0.27}Mg_{0.10}Ni_{3.55}Al_{0.05}Mn_{0.05}Co_{0.10} | 2 |

The results in Table 5 reveal that the battery C has a large residual discharging capacity ratio of 24% after the break for three months, while the battery T has a small residual discharging capacity ratio of 2% after the break for three months. The following shows the reason why the battery T has a small residual discharging capacity ratio of 2% after the break for three months.

When a rare earth-Mg—Ni hydrogen storage alloy (having a crystal structure such as a Ce₂Ni₇ type, a CeNi₃ type, and a Pr₅Co₁₅ type except for a CaCu₅ type) contains Mn and Co, long-term storage leads to the elution of M elements composed of Mn and Co into an electrolyte. Meanwhile, a battery having a higher power may cause short-circuit because of its thinner separator. The Mn or Co eluted into an electrolyte is accumulated on the separator, and thus such a battery readily causes a micro short circuit.

On this account, it is supposed that the battery T using the hydrogen storage alloy containing Mn and Co causes a micro short circuit due to the elution of Mn and Co into the electrolyte, and due to the thinner separator, and hence the residual discharging capacity ratio is reduced after a break for three months. In contrast, the battery C using the hydrogen storage alloy without Mn and Co causes no elution of Mn and Co into the electrolyte, and hence causes no micro short circuit even when the separator is made thinner. As a result, it is supposed that the battery C suppresses the reduction in the residual discharging capacity ratio after a break for three months.

From these results, it is desirable that the rare earth-Mg—Ni hydrogen storage alloy (having a crystal structure such as a Ce₂Ni₇ type, a CeNi₃ type, and a Pr₅Co₁₅ type except for a CaCu₅ type) contain no Mn or Co.

What is claimed is:

1. A cylindrical nickel-hydrogen storage battery comprising:
a spiral electrode group, the spiral electrode group including:
a nickel positive electrode filled with a positive electrode active material and formed into a rectangular shape,
a negative electrode filled with a negative electrode active material and formed into a rectangular shape, and
a separator formed into a rectangular shape;
an alkaline electrolyte; and
a battery container storing therein the spiral electrode group and the alkaline electrolyte and sealed,
the nickel positive electrode formed into a rectangular shape having a short side length of X (mm) and a long side length of Y (mm), the ratio (Y/X) of the long side length to the short side length being 25 or more and 40 or less (25≦Y/X≦40), and the short side length being 25 mm or more and 45 mm or less (25 mm≦X≦45 mm), and
the cylindrical nickel-hydrogen storage battery having a battery capacity of 3 Ah or more and 7 Ah or less.

2. The cylindrical nickel-hydrogen storage battery according to claim 1, wherein the nickel positive electrode is prepared by filling pores of a nickel sintered substrate with at least nickel hydroxide as a main positive electrode active material and zinc by impregnation treatment of an impregnation solution and alkaline treatment.

3. The cylindrical nickel-hydrogen storage battery according to claim 2, wherein the zinc is contained in an amount of 8% by mass or less based on the nickel mass in the positive electrode active material, the alkaline electrolyte has an alkali concentration of 6.5 mol/L or less, and the alkaline electrolyte contains lithium (Li) in an amount of 0.3 mol/L or more.

4. The cylindrical nickel-hydrogen storage battery according to claim 2, wherein the zinc is contained in an amount of 8% by mass or less based on the nickel mass in the positive electrode active material, the alkaline electrolyte has an alkali concentration of 7.5 mol/L or less, and the alkaline electrolyte contains sodium (Na) in an amount of 0.4 mol/L or more and 5.3 mol/L or less and lithium (Li) in an amount of 0.3 mol/L or less.

5. The cylindrical nickel-hydrogen storage battery according to claim 1, wherein the negative electrode active material is a rare earth-Mg—Ni hydrogen storage alloy (having a crystal structure such as a Ce₂Ni₇ type, a CeNi₃ type, and a Pr₅Co₁₅ type except for a CaCu₅ type) and contains no manganese (Mn) or cobalt (Co).
